(19) United States
(12) Patent Application Publication
(10) Pub. No.: US 2001/0054684 A1
(43) Pub. Date: Dec. 27, 2001

(54) SURFACE INDUCED DISSOCIATION WITH PULSED ION EXTRACTION

(76) Inventor: MELVIN A. PARK, BILLERICA, NH (US)

Correspondence Address: WARD & OLIVO, 708 THIRD AVENUE, NEW YORK, NY, 10017

(21) Appl. No.: 09/087,535

(22) Filed: May 29, 1998

(51) Int. Cl. H01J 49/00; B01D 59/44

(52) U.S. Cl. 250/287

(57) ABSTRACT

The present invention relates generally to time-of-flight mass spectrometers and discloses an improved method and apparatus for analyzing ions using a time-of-flight mass spectrometer. More specifically, a means and method are described for the use of tandem time-of-flight mass spectrometry in conjunction with surface induced dissociation and pulsed ion extraction for fragmentation and analysis of selected sample ions. The concept essential to SID with PIE is that the kinetic energy of product and scattered ions can be correlated with their position at some time T after the collision event, and by using this relationship, one can reduce the distribution of either the kinetic energy of the ions or the arrival times of the ions at some position in the spectrometer. Ions are produced from sample material in an ion source and pulsed into the SID-PIE instrument. The packet of ions thus produced may or may not be mass analyzed before striking the SID surface. Ions of interest are accelerated to a kinetic energy appropriate to the desired fragmentation and then allowed to strike the SID surface.

### TECHNICAL FIELD OF THE INVENTION

This invention relates generally to the mass spectroscopic analysis of chemical samples and more particularly to time-of-flight mass spectrometry. More specifically, a means and method are described for the use of tandem time-of-flight mass spectrometry in conjunction with surface induced dissociation and pulsed ion extraction for fragmentation and analysis of selected sample ions.

### BACKGROUND OF THE INVENTION

This invention relates in general to ion beam handling in mass spectrometers and more particularly to a means for fragmenting and analyzing ions in tandem time-of-flight mass spectrometers (TOFMS). The apparatus and method of mass analysis described herein are an enhancement of the techniques that are referred to in the literature relating to mass spectrometry.

The analysis of ions by mass spectrometers is important, as mass spectrometers are instruments that are used to determine the chemical structures of molecules. In these instruments, molecules become positively or negatively charged in an ionization source and the masses of the resultant ions are determined in vacuum by a mass analyzer that measures their mass/charge (m/z) ratio. Mass analyzers come in a variety of types, including magnetic field (B), combined (double-focusing) electrical (E) and magnetic field (B), quadrupole (Q), ion cyclotron resonance (ICR), quadrupole ion storage trap, and time-of-flight (TOF) mass analyzers, which are of particular importance with respect to the invention disclosed herein. Each mass spectrometric method has a unique set of attributes. Thus, TOFMS is one mass spectrometric method that arose out of the evolution of the larger field of mass spectrometry.

The analysis of ions by TOFMS is, as the name suggests, based on the measurement of the flight times of ions from an initial position to a final position. Ions which have the same initial kinetic energy but different masses will separate when allowed to drift through a field free region.

Ions are conventionally extracted from an ion source in small packets. The ions acquire different velocities according to the mass-to-charge ratio of the ions. Lighter ions will arrive at a detector prior to high mass ions. Determining the time-of-flight of the ions across a propagation path permits the determination of the masses of different ions. The propagation path may be circular or helical, as in cyclotron resonance spectrometry, but typically linear propagation paths are used for TOFMS applications.

TOFMS is used to form a mass spectrum for ions contained in a sample of interest. Conventionally, the sample is divided into packets of ions that are launched along the propagation path using a pulse-and-wait approach. In releasing packets, one concern is that the lighter and faster ions of a trailing packet will pass the heavier and slower ions of a preceding packet. Using the traditional pulse-and-wait approach, the release of an ion packet as timed to ensure that the ions of a preceding packet reach the detector before any overlap can occur. Thus, the periods between packets is relatively long. If ions are being generated continuously, only a small percentage of the ions undergo detection. A significant amount of sample material is thereby wasted. The loss in efficiency and sensitivity can be reduced by storing ions that are generated between the launching of individual packets, but the storage approach carries some disadvantages.

Resolution is an important consideration in the design and operation of a mass spectrometer for ion analysis. The traditional pulse-and-wait approach in releasing packets of ions enables resolution of ions of different masses by separating the ions into discernible groups. However, other factors are also involved in determining the resolution of a mass spectrometry system. “Space resolution” is the ability of the system to resolve ions of different masses despite an initial spatial position distribution within an ion source from which the packets are extracted. Differences in starting position will affect the time required for traversing a propagation path. “Energy resolution” is the ability of the system to resolve ions of different mass despite an initial velocity distribution. Different starting velocities will affect the time required for traversing the propagation path.

In addition, two or more mass analyzers may be combined in a single instrument to form a tandem mass spectrometer (MS/MS, MS/MS/MS, etc.). The most common MS/MS instruments are four sector instruments (EBEB or BEEB), triple quadrupoles (QQQ), and hybrid instruments (EBQQ or BEQQ). The mass/charge ratio measured for a molecular ion is used to determine the molecular weight of a compound. In addition, molecular ions may dissociate at specific chemical bonds to form fragment ions. Mass/charge ratios of these fragment ions are used to elucidate the chemical structure of the molecule. Tandem mass spectrometers have a particular advantage for structural analysis in that the first mass analyzer (MS1) can be used to measure and select molecular ion from a mixture of molecules, while the second mass analyzer (MS2) can be used to record the structural fragments. In tandem instruments, a means is provided to induce fragmentation in the region between the two mass analyzers. The most common method employs a collision chamber filled with an inert gas, and is known as collision induced dissociation CID. Such collisions can be carried out at high (5-10 keV) or low (10-100 eV) kinetic energies, or may involve specific chemical (ion-molecule) reactions. Fragmentation may also be induced using laser beams (photodissociation) electron beams (electron induced dissociation), or through collisions with surfaces (surface induced dissociation). It is possible to perform such an analysis using a variety of types of mass analyzers including TOF mass analysis.

In a TOFMS instrument, molecular and fragment ions formed in the source are accelerated to a kinetic energy:

$$e V = \frac{1}{2} {mv}^{2} \qquad ( 1 )$$

where e is the elemental charge, V is the potential across the source/accelerating region, m is the ion mass, and v is the ion velocity. These ions pass through a field-free drift region of length L with velocities given by equation 1. The time required for a particular ion to traverse the drift region is directly proportional to the square root of the mass/charge ratio:

$$t = L \sqrt{\frac{m}{2 e V}} \qquad ( 2 )$$

Conversely, the mass/charge ratios of ions can be determined from their flight times according to the equation:

$$\frac{m}{e} = {at}^{2} - b \qquad ( 3 )$$

where a and b are constants which can be determined experimentally from the flight times of two or more ions of known mass/charge ratios.

Generally, TOF mass spectrometers have limited mass resolution. This arises because there may be uncertainties in the time that the ions were formed (time distribution), in their location in the accelerating field at the time they were formed (spatial distribution), and in their initial kinetic energy distributions prior to acceleration (energy distribution).

The first commercially successful TOFMS was based on an instrument described by Wiley and McLaren in 1955 (Wiley, W. C.; McLaren, I. H., Rev. Sci. Instrumen. 26 1150 (1955)). That instrument utilized electron impact (EI) ionization (which is limited to volatile samples) and a method for spatial and energy focusing known as time-lag focusing. In brief, molecules are first ionized by a pulsed (1-5 microsecond) electron beam. Spatial focusing was accomplished using multiple-stage acceleration of the ions. In the first stage, a low voltage (−150 V) drawout pulse is applied to the source region that compensates for ions formed at different locations, while the second (and other) stages complete the acceleration of the ions to their final kinetic energy (−3 keV). A short time-delay (1-7 microseconds) between the ionization and drawout pulses compensates for different initial kinetic energies of the ions, and is designed to improve mass resolution. Because this method required a very fast (40 ns) rise time pulse in the source region, it was convenient to place the ion source at ground potential, while the drift region floats at −3 kV. The instrument was commercialized by Bendix Corporation as the model NA-2, and later by CVC Products (Rochester, N.Y.) as the model CVC-2000 mass spectrometer. The instrument has a practical mass range of 400 daltons and a mass resolution of 1/300, and is still commercially available.

There have been a number of variations on this instrument. Muga (TOFTEC, Gainsville) has described a velocity compaction technique for improving the mass resolution (Muga velocity compaction). Chatfield et al. (Chatfield FT-TOF) described a method for frequency modulation of gates placed at either end of the flight tube, and Fourier transformation to the time domain to obtain mass spectra. This method was designed to improve the duty cycle.

Cotter et al. (VanBreeman, R. B.: Snow, M.: Cotter, R. J., Int. J. Mass Spectrom. Ion Phys. 49 (1983) 35.; Tabet, J. C.; Cotter, R. J., Anal. Chem. 56 (1984) 1662; Olthoff, J. K.; Lys, I.: Demirev, P.: Cotter, R. J., Anal. Instrumen. 16 (1987) 93, modified a CVC 2000 time-of-flight mass spectrometer for infrared laser desorption of involatile biomolecules, using a Tachisto (Needham, Mass.) model 215G pulsed carbon dioxide laser. This group also constructed a pulsed liquid secondary time-of-flight mass spectrometer (liquid SIMS-TOF) utilizing a pulsed (1-5 microsecond) beam of 5 keV cesium ions, a liquid sample matrix, a symmetric push/pull arrangement for pulsed ion extraction (Olthoff, J. K.; Cotter, R. J., Anal. Chem. 59 (1987) 999-1002.; Olthoff, J. K.; Cotter, R. J., Nucl. Instrum. Meth. Phys. Res. B-26 (1987) 566-570. In both of these instruments, the time delay range between ion formation and extraction was extended to 5-50 microseconds, and was used to permit metastable fragmentation of large molecules prior to extraction from the source. This in turn reveals more structural information in the mass spectra.

The plasma desorption technique introduced by Macfarlane and Torgerson in 1974 (Macfarlane, R. D.; Skowronski, R. P.; Torgerson, D. F., Biochem. Biophys. Res Commoun. 60 (1974) 616.) formed ions on a planar surface placed at a voltage of 20 kV. Since there are no spatial uncertainties, ions are accelerated promptly to their final kinetic energies toward a parallel, grounded extraction grid, and then travel through a grounded drift region. High voltages are used, since mass resolution is proportional to U o/;eV, where the initial kinetic energy, U 0/is of the order of a few electron volts. Plasma desorption mass spectrometers have been constructed at Rockefeller (Chait, B. T.; Field, F. H., J. Amer. Chem. Soc. 106 (1984) 193), Orsay (LeBeyec, Y.; Della Negra, S.; Deprun, C.; Vigny, P.; Giont, Y. M., Rev. Phys. Appl 15 (1980) 1631), Paris (Viari, A.; Ballini, J. P.; Vigny, P.; Shire, D.; Dousset, P., Biomed. Environ. Mass Spectrom, 14 (1987) 83), Upsalla (Hakansson, P.; Sundqvist B., Radiat. Eff. 61 (1982) 179) and Darmstadt (Becker, O.; Furstenau, N.; Krueger, F. R.; Weiss, G.; Wein, K., Nucl. Instrum. Methods 139 (1976) 195). A plasma desorption time-of-flight mass spectrometer has bee commercialized by BIO-ION Nordic (Upsalla, Sweden). Plasma desorption utilizes primary ion particles with kinetic energies in the MeV range to induce desorption/ionization. A similar instrument was constructed at Manitobe (Chain, B. T.; Standing, K. G., Int. J. Mass Spectrum. Ion Phys. 40 (1981) 185) using primary ions in the keV range, but has not been commercialized.

Matrix-assited laser desorption, introduced by Tanaka et al. (Tanaka, K.; Waki, H.; Ido, Y.; Akita, S.; Yoshida, Y.; Yoshica, T., Rapid Commun. Mass Spectrom. 2 (1988) 151) and by Karas and Hillenkamp (Karas, M.; Hillenkamp, F., Anal. Chem. 60 (1988) 2299) utilizes TOFMS to measure the molecular weights of proteins in excess of 100,000 daltons. An instrument constructed at Rockefeller (Beavis, R. C.; Chait, B. T., Rapid Commun. Mass Spectrom. 3 (1989) 233) has been commercialized by VESTEC (Houston, Tex.), and employs prompt two-stage extraction of ions to an energy of 30 keV.

Time-of-flight instruments with a constant extraction field have also been utilized with multi-photon ionization, using short pulse lasers.

The instruments described thus far are linear time-of-flights, that is: there is no additional focusing after the ions are accelerated and allowed to enter the drift region. Two approaches to additional energy focusing have been utilized: those which pass the ion beam through an electrostatic energy filter.

The reflectron (or ion mirror) was first described by Mamyrin (Mamyrin, B. A.; Karatajev. V. J.; Shmikk, D. V.; Zagulin, V. A., Sov. Phys., JETP 37 (1973) 45). At the end of the drift region, ions enter a retarding field from which they are reflected back through the drift region at a slight angle. Improved mass resolution results from the fact that ions with larger kinetic energies must penetrate the reflecting field more deeply before being turned around. These faster ions than catch up with the slower ions at the detector and are focused. Reflectrons were used on the laser microprobe instrument introduced by Hillenkamp et al. (Hillenkamp, F.; Kaufmann, R.; Nitsche, R.; Unsold, E., Appl. Phys. 8 (1975) 341) and commercialized by Leybold Hereaus as the LAMMA (LAser Microprobe Mass Analyzer). A similar instrument was also commercialized by Cambridge Instruments as the IA (Laser Ionization Mass Analyzer). Benninghoven (Benninghoven reflectron) has described a SIMS (secondary ion mass spectrometer) instrument that also utilizes a reflectron, and is currently being commercialized by Leybold Hereaus. A reflecting SIMS instrument has also been constructed by Standing (Standing, K. G.; Beavis, R.; Bollbach, G.; Ens, W.; Lafortune, F.; Main, D.; Schueler, B.; Tang, X.; Westmore, J. B., Anal. Instrumen. 16 (1987) 173).

Lebeyec (Della-Negra, S.; Lebeyec, Y., in Ion Formation from Organic Solids IFOS III, ed. by A. Benninghoven, pp 42-45, Springer-Verlag, Berlin (1986)) described a coaxial reflectron time-of-flight that reflects ions along the same path in the drift tube as the incoming ions, and records their arrival times on a channelplate detector with a centered hole that allows passage of the initial (unreflected) beam. This geometry was also utilized by Tanaka et al. (Tanaka, K.; Waki, H.; Ido, Y.; Akita, S.; Yoshida, T., Rapid Comun. Mass Spectrom. 2 (1988) 151) for matrix assisted laser desorption. Schlag et al. (Grotemeyer, J.; Schlag, E. W., Org. Mass Spectrom. 22 (1987) 758) have used a reflectron on a two-laser instrument. The first laser is used to ablate solid samples, while the second laser forms ions by multiphoton ionization. This instrument is currently available from Bruker. Wollnik et al. (Grix., R.; Kutscher, R.; Li, G.; Gruner, U.; Wollnik, H., Rapid Commun. Mass Spectrom. 2 (1988) 83) have described the use of reflectrons in combination with pulsed ion extraction, and achieved mass resolutions as high as 20,000 for small ions produced by electron impact ionization.

Tandem mass spectrometers have a particular advantage for structural analysis in that a first mass analyzer (MS1) can be used to measure and select (molecular) ions from a mixture of molecules, while a second mass analyzer (MS2) can be used to analyze structurally significant fragment ions produced from the ion selected in MS1. In tandem instruments, a means may be provided to induce fragmentation in the region between the two mass analyzers. The most common method employs a collision chamber filled with an inert gas, and is known as collision induced dissociation CID. Such collisions can be carried out at high (5-10 keV) or low (10-100 eV) kinetic energies, or may involve specific chemical (ion-molecule) reactions. Fragmentation may also be induced using laser beams (photodissociation), electron beams (electron induced dissociation), or through collisions with surfaces (surface induced dissociation).

Surface induced dissociation (SID) is a method of producing “fragment” ions from “sample” ions. Ions are produced from sample molecules in an ion source. These sample ions are usually mass analyzed and a single species of ion is selected. Selected ions are accelerated to a desired kinetic energy, e.g. 70 eV, and allowed to collide with a fixed surface. The collision of the ions with the surface transforms some of the ions' kinetic energy into internal energy. As a result, the ions may dissociate to form fragment ions. Subsequent mass analysis of the fragment ions can provide information on the structure and chemistry of the original sample molecules (A. R. Dongre, V. H. Wysocki, Org. Mass Spec. 29, 700(1994); T. E. Kane, V. J. Angelico, V. H. Wysocki, Langmuir 13, 6722(1997); A. R. Dongre, A. S. Somogyi, V. H. Wysocki, J. Mass Spec. 31, 339(1996); A. R. Dongre, J. L. Jones, A. Somogyi, V. H. Wysocki, J. Am. Chem. Soc. 118, 8365(1996); W. Zhong, E. N. Nikolaev, J. H. Futrell, V. H. Wysocki, Anal. Chem. 69, 2496(1997); C. Gu, V. H. Wysocki, J. Am. Chem. Soc. 119, 12010(1997); V. H. Wysocki, J. Ding, J. L. Jones, J. H. Callahan, F. L. King, Am. Soc. Mass Spec. 3, 27(1992);A. Somogyi, T. E. Kane, J. Ding, V. H. Wysocki, J. Am. Chem. Soc. 115, 5275(1993); T. E. Kane, V. J. Angelico, V. H. Wysocki, Anal. Chem. 66, 3733(1994); T. E. Kane, V. H. Wysocki, Int. J. Mass Spec. Ion Process. 140, 177(1994)).

However, the process of colliding ions with a surface results in the production of fragment ions and scattered sample ions having a broad distribution of kinetic energies. Further, fragmentation of the sample ions occurs over a range of times after the collision. The broad distribution of kinetic energies and fragmentation times, makes the mass analysis of the scattered and fragment ions more difficult.

Ions can be mass analyzed by a variety of means including Fourier transform mass spectrometry (FTMS) and time-of-flight mass spectrometry (TOFMS). The range of kinetic energies of SID product ions leads to poor efficiency in trapping ions in a Penning (FTMS) or Paul (quadrupole ion trap mass spectrometry) type ion traps. In a prior art trap, this results in poor signal intensities and/or poor resolution depending on the conditions of the measurement. The broad distribution of kinetic energies and fragmentation times both lead to variations in ion flight times in prior art time-of-flight mass spectrometers. This leads to a loss of mass resolving power in the product ion spectrum.

In the field of Fourier Transform Ion Cyclotron Resonance Mass Spectrometry (FTICR-MS) a Penning ion trap is used to trap ions. The conventional Penning trap consists of six metal plates forming a cube in a magnetic field (M. B. Comisarow, Adv. Mass Spectrom. 8, 1698(1980); M. B. Comisarow, Int. J. Mass Spectrom. Ion Phys. 37, 251(1981)). Two of these plates (trapping plates) reside in planes perpendicular to the magnetic field whereas the other four are in planes parallel to the magnetic field. In conventional FTICR-MS, the trapping plates together with the magnetic field are used to trap ions. To accomplish this, a small electrical potential (e.g. 1 V) is applied to the trapping plates. The remaining plates are held at ground potential. The magnetic field confines ions in the plane perpendicular to the magnetic field line—the x-y plane—and the electric field produced by the potential difference between the trap electrodes confines the ions along the magnetic field lines—the z axis.

Ions in a uniform magnetic field, barring other influences, move in circular orbits (cyclotron motion) with a frequency proportional to ion mass-to-charge ratio (A. G. Marshall, L. H. Christopher, G. S. Jackson, Mass Spectrom. Rev., in press, 1998). However, the presence an electrostatic field, such as that produced by the trapping plates, produces new modes of motion (magnetron, and trapping) and alters the frequency of the cyclotron motion of the ions. This reduces the resolution of the spectrometer and causes a distortion in the relationship between ion m/z and cyclotron frequency.

The magnitude of the potentials placed on the trapping electrodes is significant both to the degree to which the cyclotron motion is distorted and to the range of z-axis kinetic energy an ion can have and still be trapped. The kinetic energy of the ions which can be trapped is directly related to the potential on the trapping electrodes, however, so is the distortion on the cyclotron motion. Thus, in a prior art FTICR cell, one would set the potential on the trapping electrodes as a compromise between trapable ion kinetic energy and distortion in cyclotron motion. Because the trapping potential must be kept low (e.g. 1 V), to avoid excessive cyclotron motion distortion, the range of trapable ion kinetic energies is also low (e.g. ˜1 eV). This limits the FTMS method in its application to external ion sources because such sources often produce ion beams which have a broad range of kinetic energies (R. C. Beavis, B. T. Chait, Chem. Phy. Lett. 181, 479(1991); T. -W. D. Chan et al., Chem. Phy. Lett. 222, 579(1994); J. A. Castoro, C. Koester, C. L. Wilkins, Rapid Commun. Mass Spectrom. 6, 239(1992); C. Koester, J. A. Castoro, C. L. Wilkins, J. Am. Chem. Soc. 114, 7572(1992); J. Yao, M. Dey, S. J. Pastor, C. L. Wilkins, Anal. Chem. 67, 3638(1995); T. Solouki, D. H. Russell, Proc. Natl. Acad. Sci. USA 89, 5701(1992); T. Solouki, K. J. Gilling, D. H. Russell, Anal. Chem. 66, 1583(1994)). In the same way this limits the FTMS method in its application to the analysis of fragment ions formed by SID. The broad distribution of ion kinetic energies formed by SID can result in poor ion trapping efficiencies and/or poor mass resolution.

Time-of-Flight mass spectrometry (TOFMS) is a means of measuring the mass-to-charge ratio (m/z) of ions via the time required for these ions to travel from a starting position to a final position. In practical applications, ions start for example at the surface of a solid sample and travel to a detector some fixed distance away. Ions may be produced from a solid sample by, for example, laser desorption. Here, a high power laser pulse incident on the sample surface causes rapid heating and thereby the desorption into the gas phase and ionization of sample molecules. Ions produced in such a manner are then accelerated towards the detector by an electric field. Acceleration occurs only over a small fraction of the distance between the sample and detector. In the remaining distance, an ion will drift at a velocity given by its m/z and the potential drop across the acceleration region. As the potential drop is presumably well known, the m/z of the ion can be determined via its velocity which is given by its flight time to the detector:

m/z=a tof²+b

where a and b are constants and tot is the flight time of the ions from the sample to the detector.

However, the velocity and therefore the determination of the m/z of an ion is typically disturbed by the presence of an initial

T(vₒ)=(−vₒ+(vₒ²+2qV/m)^{½})/(qV/md)+D/(vₒ²+2qv/m)

velocity imparted to the ion during production. In laser desorption, for example, the heating of the sample causes a Boltzmann-like distribution in the initial velocities of the ions with a peak velocity of 750 m/s or more. As a result, equation 1 can be used only as an approximation. The actual flight time of the ions, t, would cover a distribution of flight times as given by:

where vₒ is the initial velocity, V is the potential through which the ions are accelerated, q is the ion's charge, m is the mass of the ion, d is the length of the acceleration region, and D is the length of the drift region. The resolution, R, of a linear TOF mass spectrometer, given as:

R=t/2dt

where dt is the width of the observed ion signal at half the signal's intensity, is thus limited mainly by the initial velocity distribution of the ions.

To compensate the flight times of the ions for this velocity distribution, one may use a method known as pulsed ion extraction (PIE) [R. S. Brown and J. J. Lennon, Anal. Chem. 67(13), 1998(1995); R. M. Whittal and L. Li, Anal. Chem. 67 (13), 1950(1995)]. In performing conventional PIE experiments, ions are not accelerated until a set time, T, after laser desorption has occurred. At this time, the velocity, vₒ, and energy, KEₒ, of the ions as a function of distance from the sample surface, x, will be given by:

KEₒ=½m(vₒ=x/T)²

as depicted in FIG. 1. Because the initial kinetic energy of the ions in this case is a function of position, an electric field can be applied which will compensate the flight times of the ions. At the set delay time, a two gradient electric field is applied in the acceleration region. The electric fields applied resemble those used with Wiley-McLaren focusing [W. C. Wiley and I. H. McLaren, Rev. Sci. Inst. 26(12), 1150(1955)].

Wiley-McLaren focusing was developed as a method of performing TOFMS with “space” focusing. This method of space focusing is useful in situations where sample ions all have about the same initial velocity but slightly different starting positions as depicted in FIG. 2A. If space focusing is neglected, ions of a given m/z starting closer to the detector would arrive there at a shorter flight time than ions of the same m/z starting farther from the detector. As a result, equation 1 would again be useful only as an approximation and the arrival time of ions at the detector would not be strictly a function of the ions m/z. With space focusing, ions starting slightly farther from grid 1 are accelerated through a larger potential difference than ions with an initial position closer to grid 1 (see FIG. 2B). The effect of this is that all of the ions of a given m/z arrive at a position at

kₒ=(sₒE₁+d₂E₂)/sₒE₁

distance D from grid 2 at a given time after acceleration begins. This position is given by:

D=2sₒkₒ^{3/2}(1−d₂/sₒ(kₒ+kₒ^{½}))

where sₒ is the distance from grid 1 to the starting position of the ion, E₁ is the electric field strength in the first acceleration region the ion encounters, E₂ is the electric field strength in the second acceleration region the ion encounters, d₂ is the length of the second acceleration region, and D is the distance between grid 2 and the ions' temporal focal point. If the distance D is made to correspond to the distance between grid 2 and the detector, then all ions of a given m/z will be detected essentially simultaneously and the observed flight time will no longer be a function of the ion's starting position.

Pulsed ion extraction as used with TOFMS is based on a similar principle except with PIE the ions are simultaneously focused on the basis of both their kinetic energy and position because the initial kinetic energy is a function of the initial position. In the case of PIE the potential E₂ would be somewhat less than that predicted by equation 6 under a given set of circumstances. The delay in the acceleration of the ions allows ions to separate in space according to their initial velocities. Then the application of the correct potential gradient causes those ions with a lower initial velocity, and therefore greater distance from grid 1 to be accelerated to a higher final kinetic energy such that all ions of a given m/z arrive at the detector at the same time.

It should be noted that PIE has thus far been used only with TOFMS and only with ions in an ion source as opposed to ions produced by fragmentation via SID.

A conventional tandem TOFMS consists of two TOF analysis regions, MS1 and MS2, with an ion gate between the two regions. Ions of interest may be selected with the ion gate at the end of the first analyzer. As in conventional TOFMS, ions of increasing mass have decreasing velocities and increasing flight times. Thus, the arrival time of ions at the ion gate at the end of the MS1 is dependent on the mass-to-charge ratio of the ions. If one opens the ion gate only at the arrival time at the ion gate of the ion mass of interest, then only ions of that mass-to-charge will be passed into the second TOF analysis region, MS2.

MS2 consists in part of a reflectron. The flight time of an ion through a reflectron is dependent on the ion's kinetic energy. Because the kinetic energy of a product ion is directly dependent on its mass, the flight time of that ion through the reflectron is also dependent on its mass. Thus the arrival times of product ions at the end of the second TOF analysis region is dependent on the product ion mass.

If one wanted to add additional mass analysis and selection steps (i.e., MS3, MS4, . . . MSn) according to prior art, such additional analyzers would consist of reflectrons for separating fragment ions—as in MS2 above. Selection would be achieved using ion gates between each analyzer as between MS1 and MS2 above. Each new analysis and selection step would require the addition of another TOF mass analyzer and ion gate.

The purpose of the present invention is to provide an improved means of mass analyzing ions produced by SID by using PIE. When analyzing ions via TOFMS, PIE is used to time focus the ions produced by SID. When analyzing ions via FTMS or quadrupole ion trap mass spectrometry, PIE is used to energy focus ions produced by SID. Further, the present invention provides a means and method for analyzing sample ions in a multitude of activation, fragmentation, and mass analysis steps without the need for additional hardware as would be required to perform an MSⁿ analysis using conventional TOF hardware.

Several references relate to the technology herein disclosed. For example, F. Hillenkamp, M. Karas, R. C. Beavis, B. T. Chait, Anal. Chem. 63(24), 1193A(1991); Wei Hang, Pengyuan Yag, Xiaoru Wang, Chenglong Yang, Yongxuan Su, and Benli Huang, Rapid Comm. Mass Spectrom. 8, 590(1994); A. N. Verentchikov, W. Ens, K. G. Standing, Anal. Chem. 66, 126(1994); J. H. J. Dawson, M. Guilhaus, Rapid Comm. Mass Spectrom. 3, 155(1989); M. Guilhaus, J. Am. Soc. Mass Spectrom. 5, 588(1994); E. Axelsson, L. Holmlid, Int. J. Mass Spectrom. Ion Process. 59, 231(1984); O. A. Mirgorodskaya, et al., Anal. Chem. 66, 99(1994); S. M. Michael, B. M. Chien, D. M. Lubman, Anal. Chem. 65, 2614(1993); W. C. Wiley, I. H. McLaren, Rev. Sci. Inst. 26(12), 1150(1955).

### SUMMARY OF THE INVENTION

A means and method for analyzing samples which includes a surface induced dissociation apparatus and a detector. The preferred embodiment of the surface induced dissociation (SID) apparatus consists of a planar conducting electrode which acts at the surface, a first conducting grid positioned parallel to the surface electrode and a second conducting grid positioned parallel to the first grid. Potentials are applied to the grids and surface electrode such that ions entering the apparatus are decelerated before striking the collision surface. Also, the potentials applied to the grid and surface electrode are such that the region between the first grid and the collision surface is small or zero. Ions produced in an ion source enter the SID apparatus, are decelerated and collide with the surface electrode. After a delay, the ions are extracted by applying a pulsed potential to one of either the surface electrode or the first grid. The potential difference applied between the surface and the first grid accelerates the ions produced by the SID collision toward the detector. The magnitude of the potential difference applied between the surface and first grid and the delay between the ion surface collision and the application of said potential difference is selected so as to focus ions, in time, onto the detector or some other selected position in the spectrometer. As discussed above, this method, known as pulsed ion extraction (PIE) takes advantage of the correlation between ion position after the surface collision and the ions kinetic energy.

The preferred embodiment also includes an ion reflector positioned between the detector and the SID apparatus. When energized the ion reflector can reflect ions produced by the SID apparatus and extracted by pulsed ion extraction back into the SID apparatus. In the process of traveling from the SID apparatus to the reflector and back to the SID apparatus, ions separate according to their mass to charge ratio as in conventional TOFMS. Thus, it is possible to perform multiple MS-SID-PIE-MS steps before the product ions are finally detected. Ions are detected by deenergizing the ion reflector and allowing ions to pass into the detector.

### BRIEF DESCRIPTION OF THE DRAWINGS

A further understanding of the present invention can be obtained by reference to the preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawing is not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a plot of the ion initial kinetic energy and electrical potential energy vs. distance at the time of the extaction pulse assuming a 1 usec delay and an m/z of 1047;

FIG. 2A is a diagram of a prior art ion source;

FIG. 2B is a plot of the electrical potential as a function of position in the spectrometer;

FIG. 3 is a block diagram of the prefered SID-PIE mass spectrometer according to the present invention;

FIG. 4 is a timing diagram showing the sequence of events which would occur in an SID-PIE experiment;

FIG. 5 is a block diagram of the preferred embodiment of the spectrometer showing the trajectory in an MSⁿ experiment;

FIG. 6 is a timing diagram showing the sequence of events which would occur in an SID-PIE-MSN experiment;

FIG. 7 is a block diagram of an alternate embodiment SID-PIE mass spectrometer according to the present invention;

FIG. 8 is a block diagram of an alternate embodiment SID-PIE mass spectrometer according to the present invention.

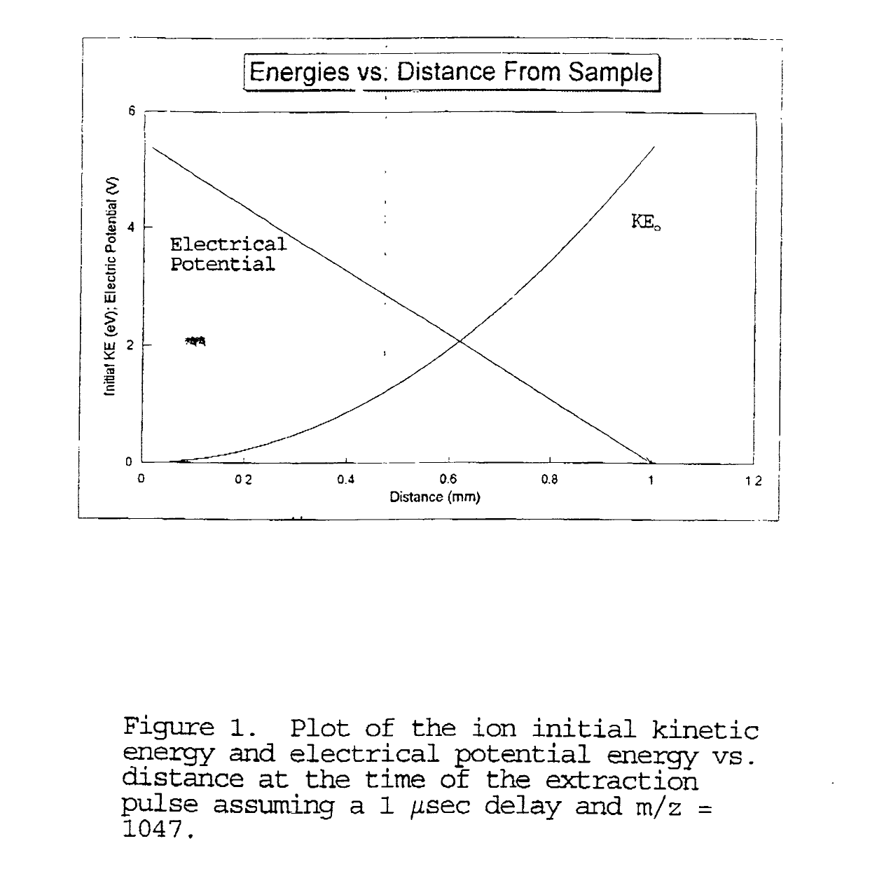

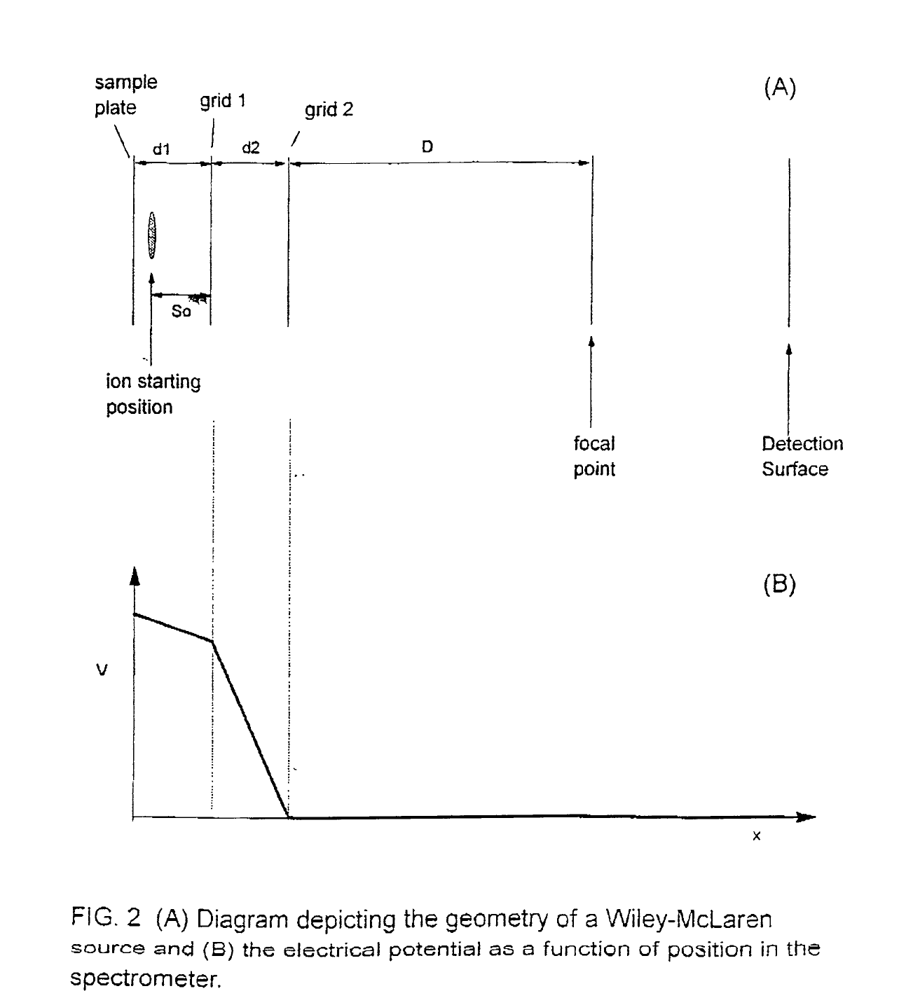

### DETAILED DESCRIPTION OF THE PREFERRED EMBODIMENT

This invention relates generally to the mass spectroscopic analysis of chemical samples and more particularly to time-of-flight mass spectrometry. More specifically, a means and method are described for the use of tandem time-of-flight mass spectrometry in conjunction with surface induced dissociation and pulsed ion extraction for fragmentation and analysis of selected sample ions.

The concept essential to SID with PIE is that the kinetic energy of product and scattered ions can be correlated with their position at some time T after the collision event, and by using this relationship, one can reduce the distribution of either the kinetic energy of the ions or the arrival times of the ions at some position in the spectrometer. Ions are produced from sample material in an ion source and pulsed into the SID-PIE instrument. The packet of ions thus produced may or may not be mass analyzed before striking the SID surface. Ions of interest are accelerated to a kinetic energy appropriate to the desired fragmentation and then allowed to strike the SID surface.

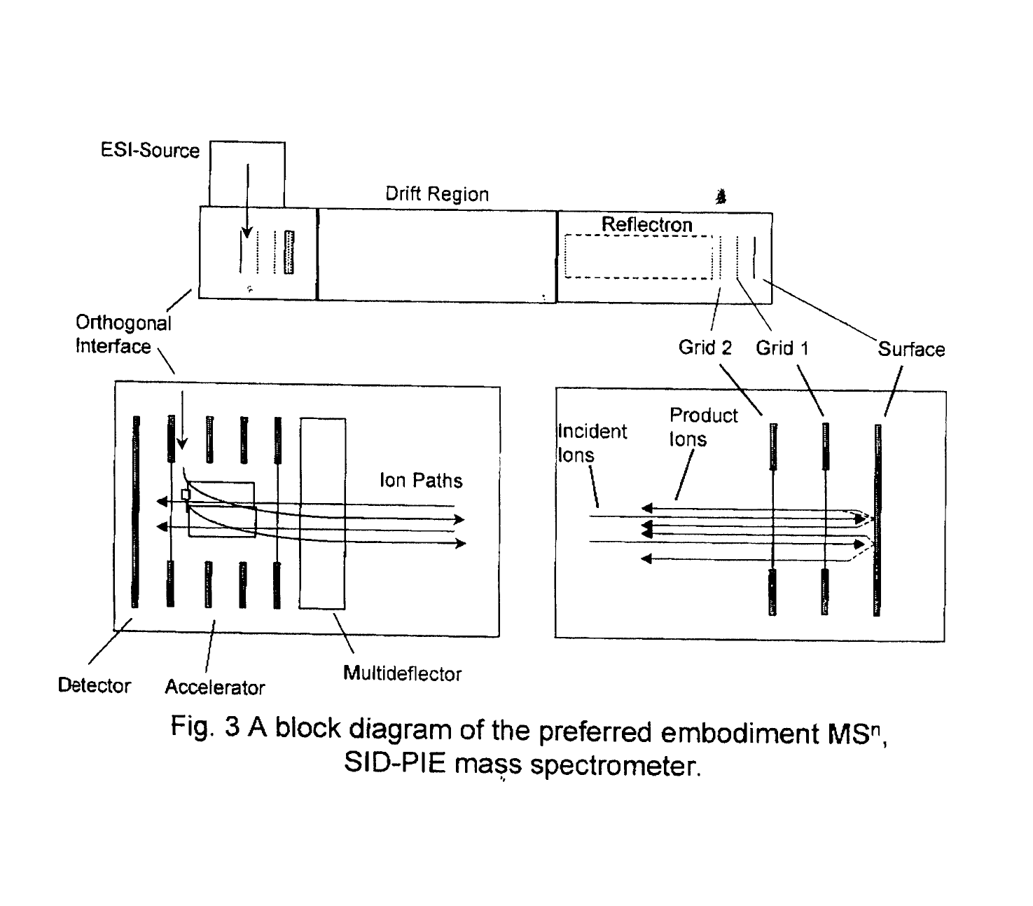

One embodiment of the SID—PIE apparatus is shown in FIG. 3. The spectrometer consists of an ion source—in this case an electrospray ionization (ESI) source—an orthogonal interface, a drift region, a reflectron, and the SID apparatus. The orthogonal interface consistes of an ion detector, an accelerator, and a multideflector. The accelerator consists of a multitude of conducting rings and is bound at either end by conducting mesh.

Initially the accelerator is deenergized—i.e. all electrodes of the accelerator are held at ground potential. Ions generated by the ion source are injected into the orthogonal interface in a direction orthogonal to the main axis of the spectrometer. The ions initially have kinetic energies on the order of 10 eV. Once the ions are in the accelerator, the accelerator is energized by applying high voltage to its component electrodes. As a result, the ions are accelerated out of the accelerator and towards the SID apparatus. Typically, the potential applied to the accelerator is 7 kV. As a result the ions have a kinetic energy of about 6.8 keV upon leaving the accelerator.

Ions will eventually travel into the reflectron, which is situated in front of the SID apparatus. If the reflectron is energized, the ions will be reflected back toward the orthogonal interface. As discussed above, the reflectron is used to improve the resolution of the mass spectra obtained from the mass spectrometer. In the present embodiment, the reflectron is used only when improved resolution is desired and not when SID-PIE is used.

When the reflectron is not energized, ions may pass through it and into the SID apparatus. The SID apparatus of the preferred embodiment according to the present invention consists of two grid electrodes and a planar conducting electrode. To perform SID-PIE, the surface and grid 1 are held at a high potential such that ions are decelerated to a kinetic energy appropriate to SID. For example, the potential on the surface and grid 1 both might be 6.75 kV. This would decelerate the 6.8 keV ions supposed above to a kinetic energy of 50 eV before the ions strike the surface.

In the preferred embodiment, grid 1 and the surface electrode are initially held at the same potential. In this case, ions which rebound from the surface after the ion surface collision will drift according to their kinetic energy on leaving the surface. After a time, for example 1 usec, the kinetic energy of the ions can be readily correlated with the ions position relative to the surface (see equation 4 above). After a strong correlation is established, the ions may be extracted via PIE such that the ions are focused in time.

Pulsed ion extraction may be accomplished by either abruptly raising the potential on the collision surface or alternatively lowering the potential on grid 1. When used with a TOF mass analyzer, the magnitude of the potentials applied to the collision surface and grids at extraction time, T, is such that ions of a particular m/z arrive at a “focal” plane simultaneously. The focal plane may coincide, for example, with the surface of a detector. Alternatively, the focal plane may be chosen to coincide with some other position in the spectrometer—e.g. an ion selector or a position where the ions are to interact with a laser or electron beam.

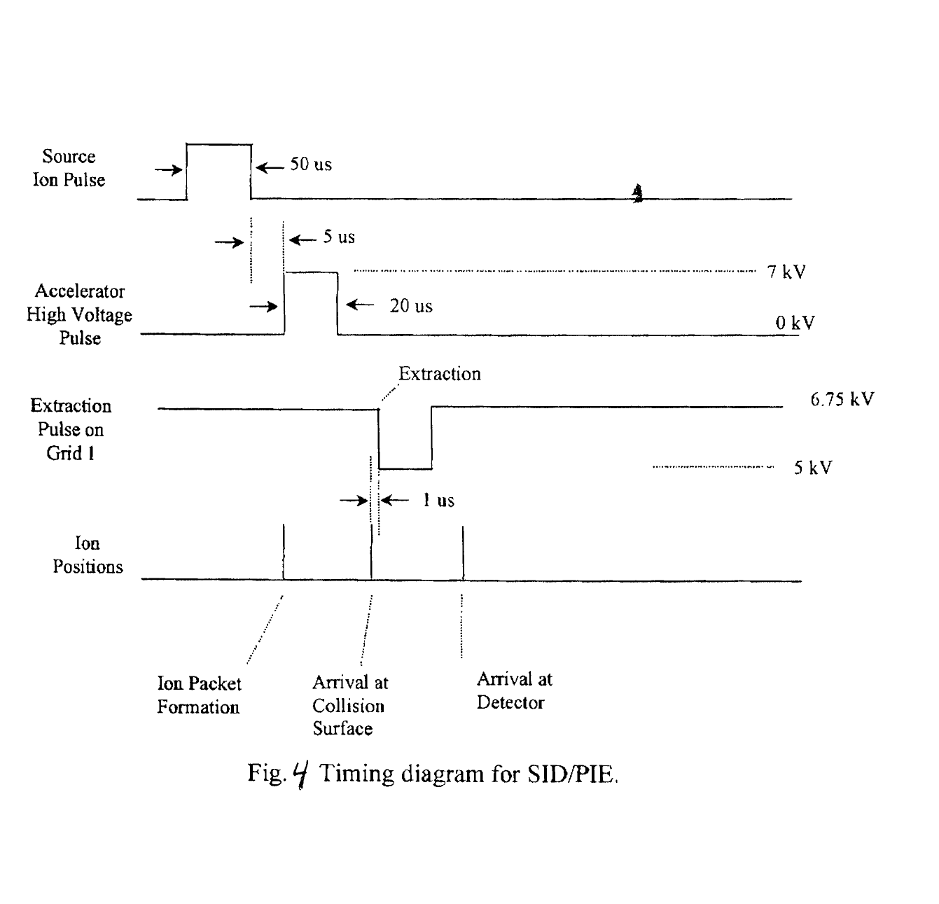

FIG. 4 depicts the timing of an SID-PIE experiment in the preferred embodiment spectrometer. Ions are generated as a pulse from the ion source. When the ions are in the accelerator, the accelerator is pulsed to 7 kV. Once the ions have been accelerated out of the accelerator, the accelerator Is brought back to ground potential. After some time, for example 40 usec, the ions collide with the SID surface. After an extraction delay of 1 usec, the ions are extracted by pulsing the potential on grid 1 down to 5 kV from 6.75 kV. Once all the ions have left the SID apparatus, the potential on grid 1 is brought back up to 6.75 kV. After drifting through the accelerator, ions arrive at the detector.

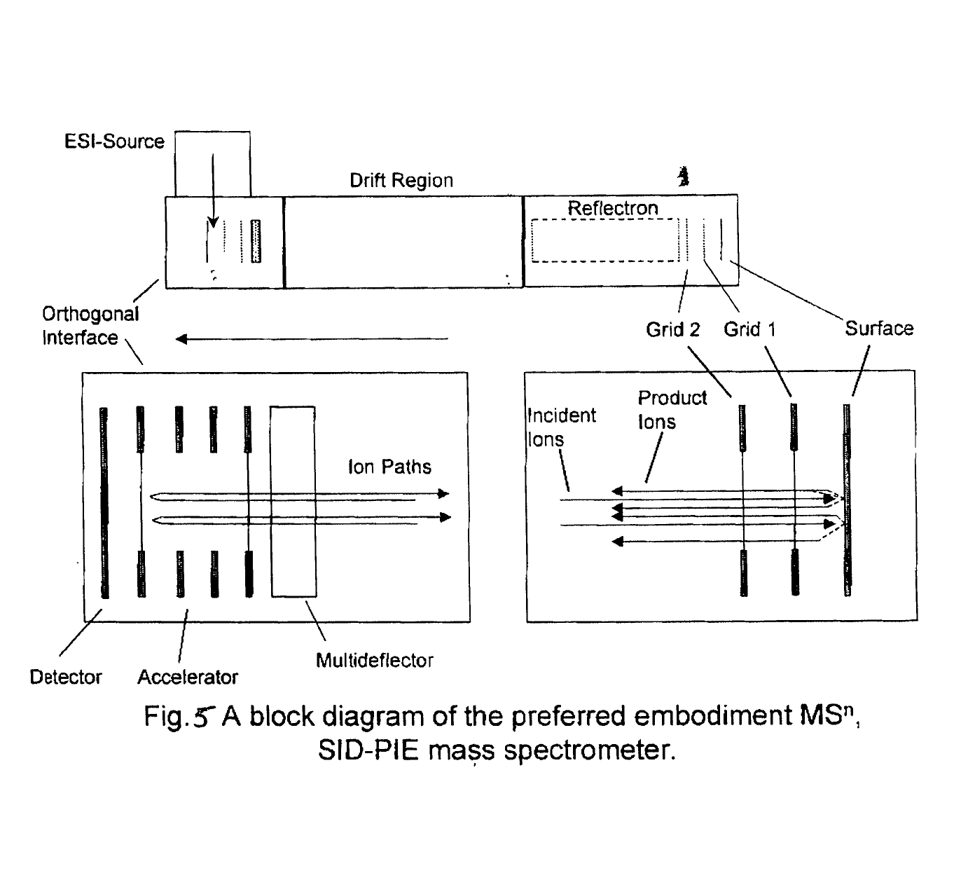

However, as depicted in FIG. 5, the accelerator may be maintained at high potential for an extended period of time. By doing this, the ions are reflected back to the SID apparatus and can undergo a second collision with the surface. In this manner, one may perform many consecutive TOF, SID-PIE, TOF analyses on a group of ions thus achieving MSⁿ.

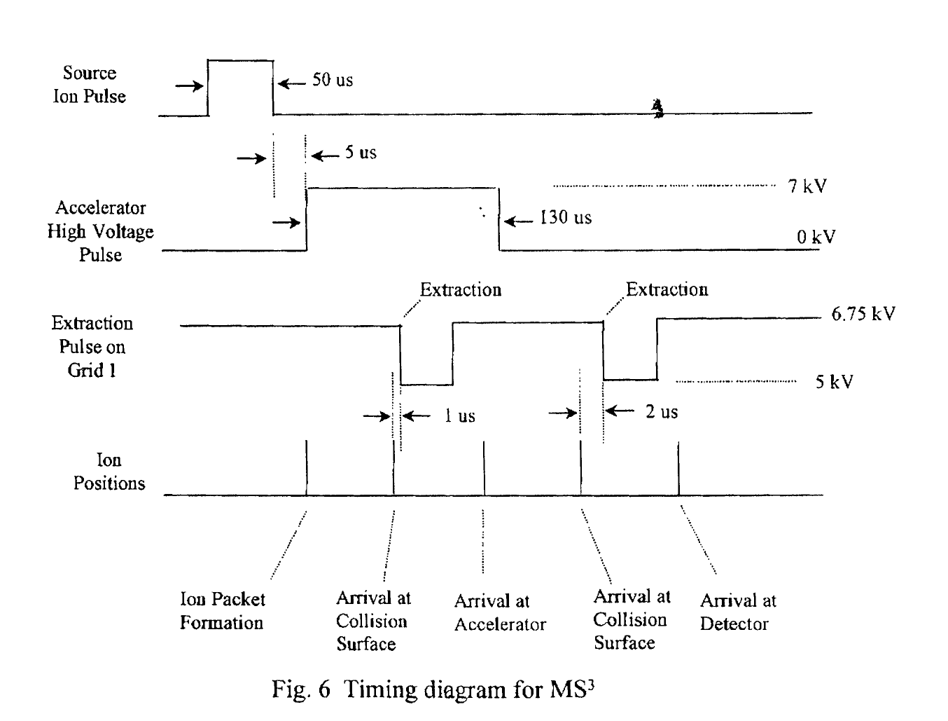

FIG. 6 depicts the timing of an MS³ SID-PIE experiment in the preferred embodiment spectrometer. As described above ions are generated as a pulse from the ion source. When the ions are in the accelerator, the accelerator is pulsed to 7 kV. Once the ions have been accelerated out of the accelerator, the accelerator Is brought back to ground potential. After some time, for example 40 usec, the ions collide with the SID surface. After an extraction delay of 1 usec, the ions are extracted by pulsing the potential on grid 1 down to 5 kV from 6.75 kV. Once all the ions have left the SID apparatus, the potential on grid 1 is brought back up to 6.75 kV. The ions travel to and are reflected by the accelerator. Once all the ions of interest have been reflected, the accelerator Is brought back to ground potential. Eventually, the ions arrive again at the SID apparatus and strike the SID surface. After an extraction delay of, for example, 2 usec the product ions are extracted by pulsing the potential on grid 1 down to 5 kV from 6.75 kV. Once all the ions have left the SID apparatus, the potential on grid 1 is brought back up to 6.75 kV. After drifting through the accelerator, ions arrive at the detector. By extending this series of pulses, this method may be extended to as many MS steps as desired.

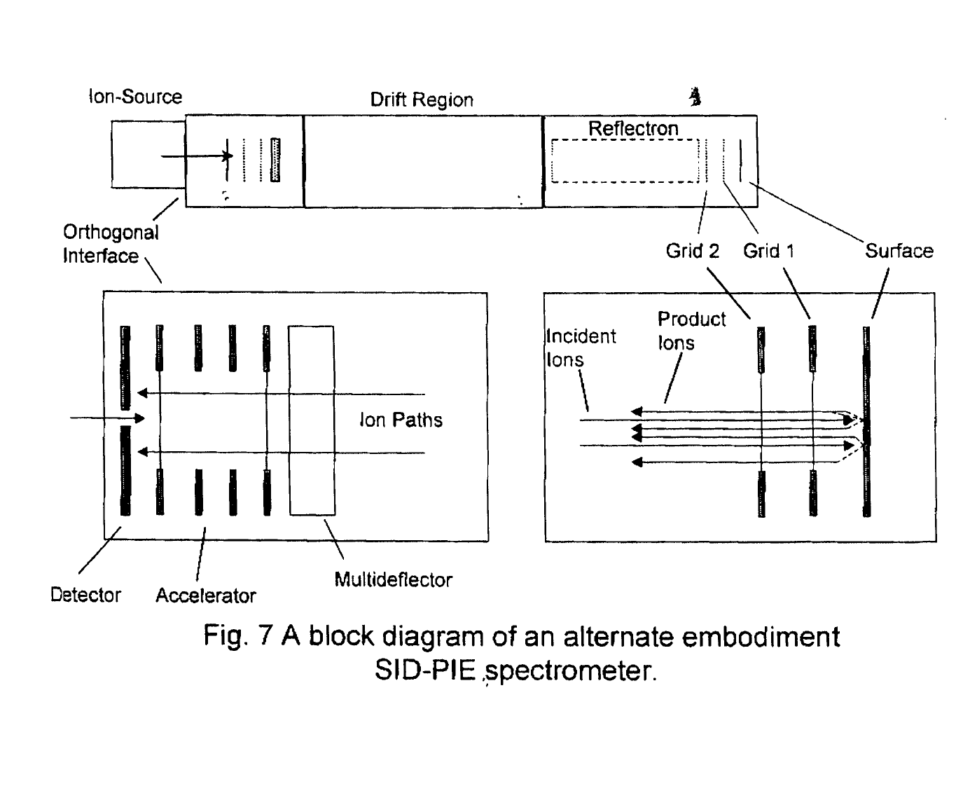

FIG. 7 is a block diagram of an alternate embodiment SID-PIE spectrometer. In this embodiment, the ion source is arranged coaxially with the TOF analyzer. Ions are accelerated to their “final” kinetic energy within the ion source rather than by the accelerator. Ions enter the orthogonal interface through a hole in the detector. Initially the accelerator is at ground potential so ions pass directly through the accelerator and on toward the SID apparatus. Ions strike the collision surface and are extracted as described above. Ions returning from the SID apparatus again pass through the accelerator and are detected by the detector. The multideflector in this case remains deenergized throughout the experiment.

To perform an MSⁿ, the accelerator is energized to reflect ions back to the SID apparatus. Again, ions are accelerated to their “final” kinetic energy within the ion source rather than by the accelerator. Ions enter the orthogonal interface through a hole in the detector. Initially the accelerator is at ground potential so that ions pass directly through the accelerator and on toward the SID apparatus. Once all ions of interest have pass through the accelerator, the accelerator is biased to a potential sufficient to reflect product ions of interest produced in the SID apparatus. Ions strike the collision surface and are extracted as described above. Ions returning from the SID apparatus are reflected by the accelerator back toward the SID apparatus. Once all the ions of interest have been reflected, the accelerator is brought back to ground potential. The reflected ions again strike the SID apparatus and are again exracted as described above. Product ions from this SID-PIE process pass through the accelerator and are detected by the detector.

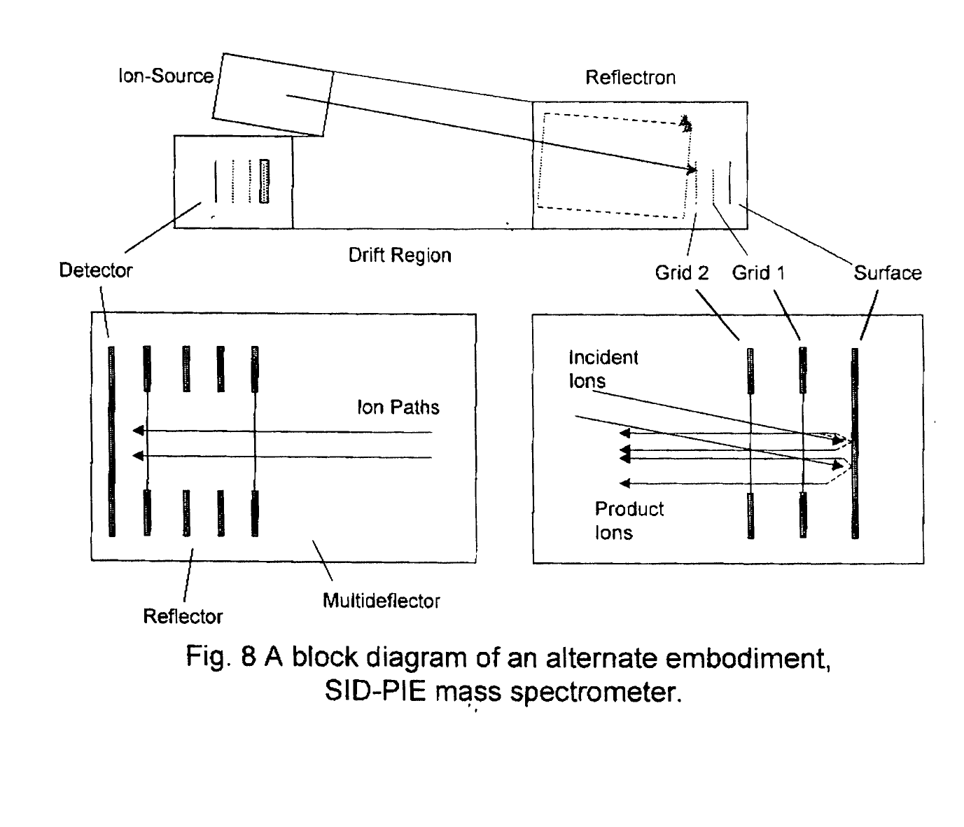

FIG. 8 is a block diagram of a third embodiment SID-PIE spectrometer. In this embodiment, the ion source is arranged of axis from the SID-PIE and detector TOF analyzer. It is important to recognize that the path from the ion source to the SID apparatus in all above embodiments represents a first TOF mass analysis. The path from the SID apparatus to the detector represents a second TOF mass analysis. Ions are accelerated to their “final” kinetic energy within the ion source rather than by the accelerator. The spectrometer according to this embodiment has no orthogonal interface, rather ions drift directly from the ion source to the SID apparatus. Ions strike the collision surface and are extracted as described above. To perform MS/MS by TOF analysis/SID-PIE/TOF analysis, the accelerator is at ground potential so ions can pass through to the detector.

To perform an MSⁿ, the accelerator is energized to reflect ions back to the SID apparatus. Again, ions are accelerated to their “final” kinetic energy within the ion source rather than by the accelerator. Ions drift from the source to the SID apparatus. Ions strike the collision surface and are extracted toward the detector as described above. Initially the accelerator is biased to a potential sufficient to reflect product ions of interest produced in the SID apparatus. Ions comming from the SID apparatus are reflected by the accelerator back toward the SID apparatus. Once all the ions of interest have been reflected, the accelerator is brought back to ground potential. The reflected ions again strike the SID apparatus and are again exracted as described above. Product ions from this SID-PIE process pass through the accelerator and are detected by the detector.

Although not specifically shown above, an ion selector in the form of deflection plates may be used to select ions of interest either from the initial ion beam or from the product ion beam resulting from an SID-PIE step (see for example U.S. Pat. No. 5,753,909). The ion selector represents the boundry between one mass analyzer (or mass analysis step) and the next. That is, ions are separated from each other by their time of flight from the source to the ion selector. Ions of interest are selected by the ion selector and passed on to the SID apparatus (and thereby the subsequent mass analysis step).

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

What is claimed is:

1. An apparatus for a time-of-flight mass spectrometer, said apparatus comprising:
an electrospray ionization source having an orthogonal interface which comprises of an ion detector, an ion accelerator, and a multideflector;
a drift region;
a reflectron;
the SID apparatus; and
an ion detector;
wherein said reflectron is arranged coaxially with said ion accelerator; wherein said ions are introduced into said ion accelerator from said electrospray ionization source; wherein said ions are repeatedly reflected back and forth between said ion accelerator and said reflectron while said ion accelerator and said reflectron are energized to a potential; and wherein said ions are detected by said ion detector while at least one of said ion accelerator or said reflectron are deenergized.
